(19) United States
(12) Patent Application Publication
(10) Pub. No.: US 2024/0369030 A1
(43) Pub. Date: Nov. 7, 2024

(54) SINGLE STAGE HIGH EFFICIENCY VAPOR MANAGEMENT VALVE

(71) Applicant: Eaton Intelligent Power Limited, Dublin (IE)

(72) Inventor: Raymond Bruce Mclauchlan, Macomb Township, MI (US)

(21) Appl. No.: 18/777,384

(22) Filed: Jul. 18, 2024

Related U.S. Application Data
(63) Continuation of application No. PCT/EP2023/025018, filed on Jan. 19, 2023.
(60) Provisional application No. 63/300,809, filed on Jan. 19, 2022.

(51) Int. Cl. F02M 25/08

(52) U.S. Cl. CPC F02M 25/0836; F02M 2025/0845

(57) ABSTRACT

A fuel tank isolation valve assembly configured to selectively vent fuel vapor from a fuel tank to a vapor recovery canister includes a housing having an inlet and an outlet. The valve assembly is fluidly coupled between the fuel tank and the vapor recovery canister. The inlet is fluidly coupled to a vapor space of the fuel tank, and the outlet is fluidly coupled to the vapor recovery canister. The housing generally defines an inlet cavity, a flow passage cavity that defines a flow passage cavity axis, an over-pressure relief (OPR) cavity that defines an OPR cavity axis and an outlet cavity. The flow passage cavity axis and the OPR cavity axis are colinear.

### PRIORITY

This application claims the benefit under 35 U.S.C. § 365 (c) of International Patent Application No. PCT/EP2023/025018, filed 19 Jan. 2023, which claims the benefit under 35 U.S.C. § 119 (c) of U.S. Provisional Patent Application No. 63/300,809, filed 19 Jan. 2022, all of which are incorporated herein by reference.

### TECHNICAL FIELD

The present disclosure relates generally to fuel tanks on passenger vehicles and more particularly to a fuel tank isolation valve having a transverse connection architecture and an integrated or separable pressure sensing device.

### BACKGROUND

Fuel vapor emission control systems are becoming increasingly more complex, in large part in order to comply with environmental and safety regulations imposed on manufacturers of gasoline powered vehicles. Along with the ensuing overall system complexity, complexity of individual components within the system has also increased. Certain regulations affecting the electric hybrid and gasoline-powered vehicle industry require that fuel vapor emission from a fuel tank's ventilation system be stored during periods of an engine's operation. In order for the overall vapor emission control system to continue to function for its intended purpose, periodic purging of stored hydrocarbon vapors is necessary during operation of the vehicle.

High-pressure fuel tanks may use an isolation valve to open and close a vapor path between the fuel tank and a vapor recovery canister. For high-pressure fuel tank systems, an isolation valve may be used to isolate fuel tank emissions and prevent them from overloading the canister and vapor lines. The isolation valve itself may be a normally closed valve that is opened to allow vapor flow for tank depressurization or any other event where vapor release is desired. While existing isolation valves work for their intended purpose, a need exists to further the art.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY OF PARTICULAR EMBODIMENTS

A fuel tank isolation valve assembly configured to selectively vent fuel vapor from a fuel tank to a vapor recovery canister includes a housing having an inlet and an outlet. The valve assembly is fluidly coupled between the fuel tank and the vapor recovery canister. The inlet is fluidly coupled to a vapor space of the fuel tank, and the outlet is fluidly coupled to the vapor recovery canister. The housing generally defines an inlet cavity, a flow passage cavity that defines a flow passage cavity axis, an over-pressure relief (OPR) cavity that defines an OPR cavity axis, and an outlet cavity. The flow passage cavity axis and the OPR cavity axis are colinear.

In additional features, the fuel tank isolation valve assembly includes an armature and a poppet. The armature can have a first coupling surface. The poppet can have a proximal end and a distal end. The proximal end can include a second coupling structure that couples to the first coupling structure. The distal end can include a seal. The seal can further comprise an outboard seal portion configured to selectively seal against the housing and an inboard seal portion configured to selectively seal against a hat valve, wherein the hat valve is normally urged against the inboard seal portion by a biasing member.

In examples, the hat valve can define a conical cavity that receives a stem extending from the distal end of the poppet. The conical cavity can urge the stem to positively located relative to the hat valve. The first coupling structure can include a neck and a disk, and the second coupling structure includes a hook portion that defines an inlet and a cavity, wherein the disk of the armature is configured to be accepted within the cavity by way of the inlet. The disk can be configured to translate a distance between surfaces defined on the proximal end of the poppet without translating the poppet. The inlet and outlet can be arranged on the housing at a transverse relationship. The inlet can define the inlet cavity and the outlet can define the outlet cavity, wherein the inlet cavity defines an inlet axis, wherein the inlet axis and the OPR axis are non-parallel, and wherein the inlet axis and the OPR axis are transverse. A passage defined between the flow passage cavity and the OPR cavity can define a passage axis that is parallel to the OPR axis.

A fuel tank isolation valve assembly configured to selectively vent fuel vapor from a fuel tank to a vapor recovery canister can include a housing, a solenoid assembly, and a poppet. The housing can have an inlet and an outlet, wherein the valve assembly is fluidly coupled between the fuel tank and the vapor recovery canister. The inlet is fluidly coupled to a vapor space of the fuel tank. The outlet can be fluidly coupled to the vapor recovery canister, wherein the inlet and outlet are arranged on the housing at a transverse relationship. The solenoid assembly can be disposed in the housing and configured to selectively lift a seal in a flow passage cavity off a valve seat allowing vapor to pass from the inlet to the outlet. The poppet can be disposed in an OPR cavity in the housing and configured to facilitate opening a fuel vapor flow path from the fuel tank to the vapor recovery canister upon translation of a seal along a translation axis. The inlet can define an inlet cavity that defines an inlet axis, wherein the translation axis is transverse to the inlet axis.

In examples, the outlet defines an outlet cavity that defines an outlet axis. The inlet and outlet axes are transverse. A passage defined between the flow passage cavity and the OPR cavity can define a passage axis that is parallel to the translation axis. The seal can further comprise an outboard seal portion configured to selectively seal against the housing and an inboard seal portion configured to selectively seal against a hat valve disposed in the OPR cavity, wherein the hat valve is normally urged against the inboard seal portion by a biasing member. The hat valve can define a conical cavity that receives a stem extending from the distal end of the poppet. The conical cavity can urge the stem to positively locate relative to the hat valve. The first coupling structure can include a neck and a disk. The second coupling structure can include a hook portion that defines an inlet and a cavity. The disk of the armature can be configured to be accepted within the cavity by way of the inlet. The disk can be configured to translate a distance between surfaces defined on the proximal end of the poppet without translating the poppet.

A fuel tank system can include a fuel tank, a vapor recovery canister, and a valve assembly. The fuel tank can have a vapor space. The valve assembly can have a housing. The valve assembly is fluidly coupled between the fuel tank and the vapor recovery canister and arranged to selectively control fuel vapor flow between the fuel tank and the vapor recovery canister. The housing of the valve assembly includes an inlet fluidly coupled to the vapor space, a valve disposed therein, and an outlet fluidly coupled to the vapor recovery canister. The housing generally defines an inlet cavity, a flow passage cavity that defines a flow cavity axis, an over-pressure relief (OPR) cavity that defines an OPR cavity axis, and an outlet cavity. The flow passage cavity axis and the OPR cavity axis are colinear.

The fuel tank system can further comprise a controller that receives a signal from the pressure sensor and that communicates a signal to the valve assembly to open and allow vapor to pass to the vapor recovery canister. The valve assembly can further comprise a solenoid assembly arranged within the housing, wherein the solenoid assembly comprises an armature, a solenoid spring, and a coil, wherein the solenoid spring is configured to generate a force sufficient to urge the armature out of the solenoid assembly when the solenoid assembly is not energized. The armature can further comprise a first coupling structure. The valve assembly can further comprise a poppet having a proximal end and a distal end, the proximal end including a second coupling structure that couples to the first coupling structure, the distal end including a seal. The seal can further comprise an outboard seal portion configured to selectively seal against the housing and an inboard seal portion configured to selectively seal against a hat valve. The hat valve is normally urged against the inboard seal portion by a biasing member. The hat valve can be disposed in the OPR cavity. The hat valve can define a conical cavity that receives the stem extending from the distal end of the poppet. The conical cavity can urge the stem to positively locate relative to the hat valve. The first coupling structure can include a neck and a disk. The second coupling structure can include a hook portion that defines an inlet and a cavity. The disk of the armature is configured to be accepted within the cavity by way of the inlet. The disk can be configured to translate a distance between the surface defined on the proximal end of the poppet without translating the poppet.

### BRIEF DESCRIPTION OF THE DRAWINGS

The present disclosure will become more fully understood from the detailed description and the accompanying drawings, wherein:

FIG. 1 is a schematic illustration of a fuel tank system having an evaporative emissions control system including a valve assembly constructed in accordance to one example of the present disclosure and shown in cross-section;

FIG. 2 is another sectional view of the valve assembly of FIG. 1;

FIG. 3 is another perspective view of the valve assembly of FIG. 1 illustrating a mounting arrangement according to additional features of the present disclosure; and

FIG. 4 is a perspective view of a poppet of the valve assembly of FIGS. 1-3.

### DESCRIPTION OF EXAMPLE EMBODIMENTS

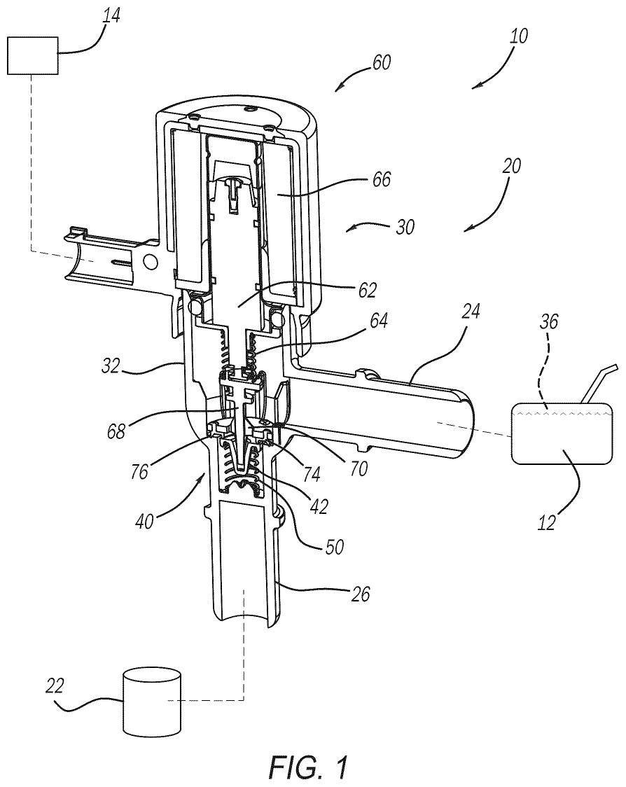

With initial reference to FIG. 1, a fuel tank system constructed in accordance with one example of the present disclosure is shown and generally identified at reference number 10. The fuel tank system 10 can generally include a fuel tank 12 configured as a reservoir for holding fuel to be supplied to an internal combustion engine via a fuel delivery system, which includes a fuel pump (not specifically shown). A controller 14 can be configured to regulate the operation of the engine and its fuel delivery system. The fuel tank 12 is operatively connected to an evaporative emissions control system 20 that includes a vapor recovery canister 22 adapted to collect fuel vapor emitted by the fuel tank 12 and to subsequently release the fuel vapor to the engine. The controller 14 can also be configured to regulate the operation of evaporative emissions control system 20 in order to recapture and recycle the emitted fuel vapor.

The evaporative emissions control system 20 includes a fuel tank isolation valve assembly 30. As will be described more fully herein, the valve assembly 30 includes a housing valve body 32 having connection architecture (inlet and outlet) oriented at a transverse relationship. As used herein, “transverse” is used to denote an angle between eighty-five and ninety-five degrees and preferably ninety degrees. An O-ring is shown generally inboard of the housing 32. In other examples, an O-ring can be additionally or alternatively provided outboard of the housing 32 to seal against the solenoid housing. While not shown, the valve assembly 30 can include a pressure sensing device. The pressure sensing device can be a sensor that is integrated with the housing 32 or separable. Additional description of a valve assembly, without the ninety-degree orientation and pressure sensing device, may be found in commonly owned U.S. Pat. No. 8,944,100 and 9,500,291, the contents of which are expressly incorporated herein by reference. In this regard, it is appreciated that the features discussed herein may be applied in other embodiments to a valve having inlet and outlets arranged at a generally parallel relationship.

As will become appreciated from the following discussion, the valve assembly 30 includes over pressure relief valve (OPR) and over vacuum release (OVR) functionality in an in-line relationship. The valve assembly 30 requires a simpler housing as compared to previous prior art examples. Only a single horizontal hydraulic core is required to make the housing rather than two as is needed in previous designs. Additionally, the valve assembly 30 incorporates reduced components as compared to previous prior art examples further reducing costs.

In general, the valve assembly 30 may control fuel vapor flow between the fuel tank 12 and the vapor recovery canister 22. While the valve assembly 30 is shown located between the fuel tank 12 and the vapor recovery canister 22, the valve assembly 30 may be configured elsewhere such as between the vapor recovery canister 22 and the engine. The controller 14 can be adapted to regulate the operation of a valve assembly 30 to selectively open and close the valve (in some cases based on a signal from the pressure sensor), in order to provide over-pressure and vacuum relief for the fuel tank 12. The pressure sensor can communicate a pressure signal to the controller 14. The valve assembly 30 can be configured to control a flow of fuel vapor between the fuel tank 12 and the vapor recovery canister 22. The valve assembly 30 includes the housing 32, which retains all internal components of the valve assembly 30. The housing 32 can connect to the fuel tank 12 via a first connector (not specifically shown) and to the vapor recovery canister 22 via a second connector (not specifically shown). In general, the housing 32 has an inlet 24 that receives fuel vapor from the fuel tank 12 and an outlet 26 that releases fuel vapor to the vapor recovery canister 22. In one configuration a vent line is coupled between the inlet 24 and a vapor space 36 in the fuel tank 12.

As shown in the FIGS, the inlet port 24 and the outlet port 26 of the housing 32 are oriented at a transverse relationship. In the example shown, the inlet port 24 and the outlet port 26 are oriented at ninety degrees relative to each other. The ninety-degree relationship provides improved packaging benefits in the fuel tank 12. Moreover, molding of the housing valve body 32 is simpler and more repeatable as compared to prior art valve assembly designs that have the inlet and outlets arranged at parallel and offset relationships relative to each other. The transverse relationship between the inlet and outlets 24 and 26 of the valve assembly 30 in the present disclosure overcomes prior art challenges and minimizes unfavorable situations such as, but not limited to, die lock that may occur during injection molding.

The pressure sensor can monitor the pressure in the tank 12 before the vapor exits to the vapor recovery canister 22. In most implementations, the valve assembly 30 can be used in a pressurized fuel system such as a hybrid vehicle fuel system. When the vehicle is operating in an electric mode, the fuel tank 12 becomes a closed (unvented) system. Fuel can be volatile from extreme temperatures and/or sloshing within the fuel tank 12 creating undesirable elevated pressure within the fuel tank 12. Such pressure can act on a compliant seal 74. The controller 14 can react (purge/vent) when the pressure sensor sends a signal to the controller 14 indicative of a pressure within the fuel tank 12 that exceeds a predetermined threshold. In other methods, the controller 14 can pulse (series of open and closing events) the valve assembly 30 during vehicle operation to relieve the pressure (over vacuum release, OVR) within the fuel tank 12.

The housing 32 accommodates the over-pressure relief (OPR) valve 40 in an in-line relationship relative to a poppet 68. The OPR valve 40 includes a piston or hat valve 42 that is configured to selectively seal against a seal 74 as will be described herein. In examples, the hat valve 42 can be formed of plastic or other suitable material. The OPR valve 40 can alternatively include a seal portion formed on the hat valve 42. Such a seal can be formed from a suitable chemically resistant elastomeric material.

The poppet 68 may be combined into a unitary piston assembly via an appropriate manufacturing process such as over-molding. The hat valve 42 is normally urged against the seal 74 to close a passage 48 by a biasing member such as a spring 50. In some configurations, the spring 50 can be rated to compress upon a threshold pressure being reached allowing the hat seal 42 to translate and mechanically open to relieve pressure (over-pressure-relief) in the fuel tank 12. The OPR valve 40 is configured to facilitate opening a first fuel vapor flow path being traversed by the fuel vapor flowing in a direction from the fuel tank 12 toward the vapor recovery canister 18 when the fuel tank 12 is above a first predetermined pressure value. The first predetermined pressure value is preferably a positive number, representing an extreme or over-pressure condition of the fuel tank 12.

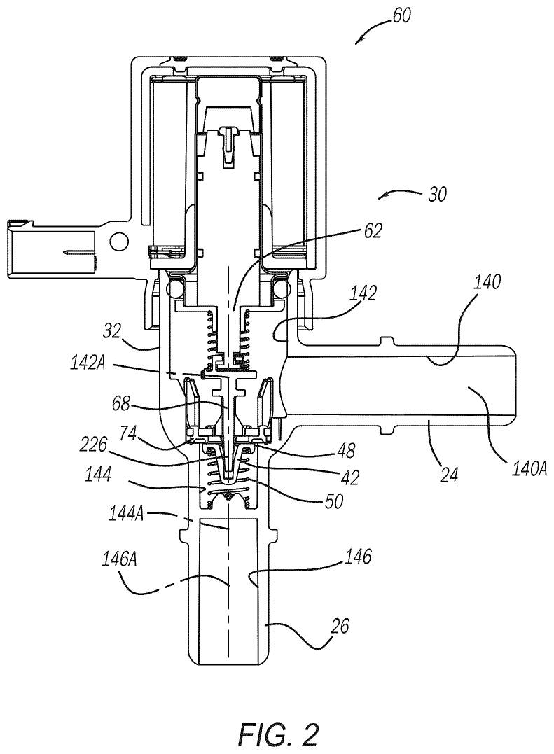

The valve assembly 30 can include a solenoid assembly 60 arranged inside the housing 32. The solenoid assembly 60 is adapted to receive electrical power from a vehicle alternator or from an energy-storage device (not shown) and be triggered or energized by a control signal from the controller 14. The solenoid assembly 60 can include an armature 62, a solenoid spring 64, and a coil 66. The solenoid spring 64 can be configured to generate a force sufficient to urge armature 62 out of the solenoid assembly 60 when the solenoid assembly 60 is not energized. The coil 66 can be configured to energize solenoid assembly 60 and to withdraw the armature 62 into the solenoid assembly 60. The armature 62 can be coupled to the poppet 68. When the armature 62 translates upwardly, the compliant seal 74 is lifted off a valve seat 76 allowing vapor to pass therethrough. In the example shown, the compliant seal 74 generally defines an outboard seal portion 74A and an inboard seal portion 74B. When the armature 62 is translated upwardly, the outboard seal portion 74A lifts off valve seat 76 on the body of the housing 32. The solenoid assembly 60 is exemplary and may be configured differently within the scope of this disclosure. The poppet 68 can additionally include flow passage channels 70 defined therein for permitting vapor flow. When a vapor pressure threshold is reached in the fuel tank 12, sufficient pressure urges the hat valve 42 against the bias of the spring 50 to move the hat valve 42 away (downward as viewed in FIG. 2) from the inboard seal portion 74B and relieve pressure (over-pressure-relief) from the fuel tank 12.

With reference to FIG. 2, the housing valve body 32 generally defines an inlet cavity 140, a flow passage cavity 142, an over-pressure relief OPR cavity 144, and an outlet cavity 146. The inlet cavity 140 defines an inlet axis 140A. The flow passage cavity 142 defines a flow passage cavity axis 142A. The OPR cavity 144 defines an OPR cavity axis 144A. The flow cavity 142 and the OPR cavity 144 are in-line with each other. The flow passage cavity axis 142A and the OPR cavity axis 144A are in-line or collinear. The outlet cavity 146 defines an outlet axis 146A. The inlet and outlet axes 140A and 146A are transverse. The inlet axis 140A and the OPR axis 144A are transverse.

Notably, the hat valve 42 resides within the OPR cavity 144. Such placement provides a simple packaging solution with reduced components over other valve configurations. Moreover, as described below, the distal end of the poppet 68 provides a locating feature that guides the hat valve 42 toward a centered position as the hat valve 42 moves toward a sealed position against the inboard seal portion 74B.

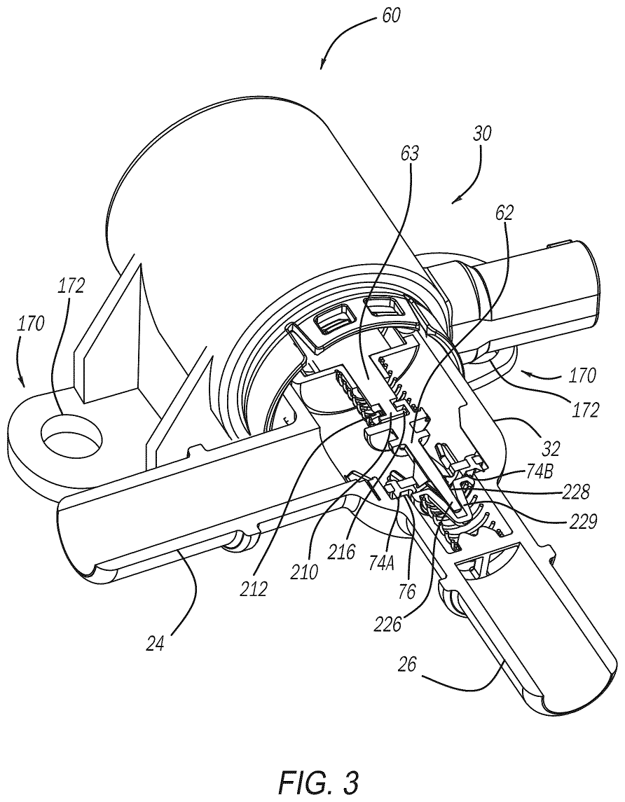

With particular reference now to FIG. 3, additional features of the instant application will be described. The housing 32 can include mounting features 170 formed thereon. In the example shown, the mounting features 170 are integrally formed with the housing 32. Grommets 172 can be arranged at the mounting features 170 for receiving fasteners. Notably, the mounting features 170 are provided at a portion of the housing that houses the solenoid assembly 60. Such an arrangement can provide a simpler and more cost-effective configuration than mounting arrangements that may be incorporated below the solenoid assembly such as associated with any of the inlet cavity 140, flow passage cavity 142, the OPR cavity 144 and/or the outlet cavity 146.

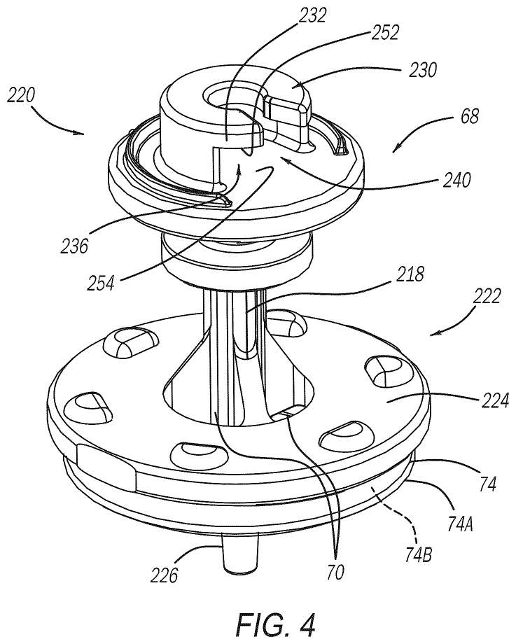

With particular reference now to FIGS. 3 and 4, additional features of the armature 62 and the poppet 68 will be described. The armature 62 generally includes a distal end having a stem or first coupling structure 210 including a neck 212 and a disk 216. The poppet 68 generally includes a one-piece body 218 having a proximal end 220 and a distal end 222. The distal end 222 includes a disk body 224 and a distal finger 226. The disk body 224 generally receives the seal 74. The distal finger 226 locates into a conical cavity 228 of the hat valve 42.

The proximal end 220 includes a second coupling structure 230 including a hook portion 232 that defines an inlet 236 and a cavity 240. The disk 216 of the armature 62 is configured to be accepted into the cavity 240 by way of the inlet 236. The disk 216 can generally translate a distance between surfaces 252, 254 of the proximal end 220 without translating the poppet 68. In other words, the stem 210 is permitted to wiggle or move a minimal amount relative to the poppet 68 without moving the poppet 68. This interaction allows the poppet 68 to properly seal as necessary without being entirely controlled by the position of the stem 210.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A fuel tank isolation valve assembly configured to selectively vent fuel vapor from a fuel tank to a vapor recovery canister, the fuel tank isolation valve assembly comprising:
a housing having an inlet and an outlet, wherein the fuel tank isolation valve assembly is fluidly coupled between the fuel tank and the vapor recovery canister, wherein the inlet is fluidly coupled to a vapor space of the fuel tank, and the outlet is fluidly coupled to the vapor recovery canister,
wherein the housing generally defines an inlet cavity, a flow passage cavity that defines a flow passage cavity axis, an over-pressure relief (OPR) cavity that defines an OPR cavity axis, and an outlet cavity, wherein the flow passage cavity axis and the OPR cavity axis are colinear.

2. The fuel tank isolation valve assembly of claim 1, further comprising:
an armature having a first coupling structure; and
a poppet having a proximal end and a distal end, the proximal end including a second coupling structure that couples to the first coupling structure, the distal end including a seal.

3. The fuel tank isolation valve assembly of claim 2, wherein the seal further comprises an outboard seal portion configured to selectively seal against the housing and an inboard seal portion configured to selectively seal against a hat valve, wherein the hat valve is normally urged against the inboard seal portion by a biasing member.

4. The fuel tank isolation valve assembly of claim 3, wherein the hat valve is disposed in the OPR cavity.

5. The fuel tank isolation valve assembly of claim 4, wherein the hat valve defines a conical cavity that receives a stem extending from the distal end of the poppet, the conical cavity urging the stem to positively locate relative to the hat valve.

6. The fuel tank isolation valve assembly of claim 5, wherein the first coupling structure includes a neck and a disk, wherein the second coupling structure includes a hook portion that defines an inlet and a cavity, wherein the disk of the armature is configured to be accepted within the cavity by way of the inlet.

7. The fuel tank isolation valve assembly of claim 6, wherein the disk is configured to translate a distance between surfaces defined on the proximal end of the poppet without translating the poppet.

8. The fuel tank isolation valve assembly of claim 1, wherein the inlet and outlet are arranged on the housing at a transverse relationship.

9. The fuel tank isolation valve assembly of claim 2, wherein the inlet defines the inlet cavity, and the outlet defines the outlet cavity, wherein the inlet cavity defines an inlet axis, wherein the inlet axis and the OPR cavity axis are non-parallel, wherein the inlet axis and the OPR cavity axis are transverse.

10. The fuel tank isolation valve assembly of claim 9, wherein a passage defined between the flow passage cavity, wherein the OPR cavity defines a passage axis that is parallel to the OPR cavity axis.

11. A fuel tank isolation valve assembly configured to selectively vent fuel vapor from a fuel tank to a vapor recovery canister, the fuel tank isolation valve assembly comprising:
a housing having an inlet and an outlet, wherein the fuel tank isolation valve assembly is fluidly coupled between the fuel tank and the vapor recovery canister, wherein the inlet is fluidly coupled to a vapor space of the fuel tank, and the outlet is fluidly coupled to the vapor recovery canister, wherein the inlet and outlet are arranged on the housing at a transverse relationship;
a solenoid assembly disposed in the housing and configured to selectively lift a seal in a flow passage cavity off a valve seat allowing vapor to pass from the inlet to the outlet; and
a poppet disposed in an OPR cavity in the housing and configured to facilitate opening a fuel vapor flow path from the fuel tank to the vapor recovery canister upon translation of the seal along a translation axis,
wherein the inlet defines an inlet cavity that defines an inlet axis, wherein the translation axis is transverse to the inlet axis.

12. The fuel tank isolation valve assembly of claim 11, wherein the outlet defines an outlet cavity that defines an outlet axis, wherein the inlet and outlet axes are transverse.

13. The fuel tank isolation valve assembly of claim 12, wherein a passage defined between the flow passage cavity and the OPR cavity defines a passage axis that is parallel to the translation axis.

14. The fuel tank isolation valve assembly of claim 13, wherein the seal further comprises an outboard seal portion configured to selectively seal against the housing and an inboard seal portion configured to selectively seal against a hat valve disposed in the OPR cavity, wherein the hat valve is normally urged against the inboard seal portion by a biasing member.

15. The fuel tank isolation valve assembly of claim 14, wherein the hat valve defines a conical cavity that receives a stem extending from a distal end of the poppet, the conical cavity urging the stem to positively locate relative to the hat valve.

16. A fuel tank system comprising:
a fuel tank having a vapor space;
a vapor recovery canister; and
a valve assembly having a housing, wherein the valve assembly is fluidly coupled between the fuel tank and the vapor recovery canister and arranged to selectively control fuel vapor flow between the fuel tank and the vapor recovery canister, wherein the housing of the valve assembly includes an inlet fluidly coupled to the vapor space, a valve disposed therein, and an outlet fluidly coupled to the vapor recovery canister, wherein the housing generally defines an inlet cavity, a flow passage cavity that defines a flow cavity axis, an over-pressure relief (OPR) cavity that defines an OPR cavity axis, and an outlet cavity, wherein the flow cavity axis and the OPR cavity axis are colinear.

17. The fuel tank system of claim 16, further comprising:
a controller that receives a signal from a pressure sensor and that communicates the signal to the valve assembly to open and allow vapor to pass to the vapor recovery canister.

18. The fuel tank system of claim 17, wherein the valve assembly further comprises:
a solenoid assembly arranged within the housing, wherein the solenoid assembly comprises an armature, a solenoid spring, and a coil, wherein the solenoid spring is configured to generate a force sufficient to urge the armature out of the solenoid assembly when the solenoid assembly is not energized.

19. The fuel tank system of claim 18, wherein the armature further comprises a first coupling structure, the valve assembly further comprising:
a poppet having a proximal end and a distal end, the proximal end including a second coupling structure that couples to the first coupling structure, the distal end including a seal.

20. The fuel tank system of claim 19, wherein the seal further comprises an outboard seal portion configured to selectively seal against the housing and an inboard seal portion configured to selectively seal against a hat valve, wherein the hat valve is normally urged against the inboard seal portion by a biasing member.
